(19) United States
(12) Patent Application Publication
(10) Pub. No.: US 2004/0145683 A1
(43) Pub. Date: Jul. 29, 2004

(54) Glass funnel for cathode-ray tube

(76) Inventor: Hajime Yoshino, Otsu-Shi (JP)

Correspondence Address: J.C. Patents, Suite 250, 4 Venture, Irvine, CA, 92618, US

(21) Appl. No.: 10/739,634

(22) Filed: Dec. 17, 2003

(30) Foreign Application Priority Data
Dec. 26, 2002 (JP) 2002-376576

(51) Int. Cl. H04N 5/65

(52) U.S. Cl. 348/818; 348/823

(57) ABSTRACT

A glass funnel for a cathode-ray tube having a thick region is provided, which aims to suppress loss of glass temperature balance between a portion having a positioning reference portion formed therein and another portion around that portion during molding, thereby reducing occurrence probability of forming defect such as deterioration of flatness or dimensional error of the positioning reference portion. In the structure including a first region serving as a thick region formed around wide opening end having a wide opening of a funnel body portion and a second region serving as a thin region formed adjacent to the first region on the narrow opening end side closer than the first region, a positioning reference portion is formed only on an outside surface of the second region. Preferably, a distance h from an outermost line near the wide opening end of the body portion along the tube axis to an edge of the first region on the narrow opening end side is set to satisfy the relation of 2 mm<h<15 mm, while a distance i from the outermost line along the tube axis to an edge of the positioning reference portion on the wide opening end side is set to satisfy the relation of i<h+20 mm.

### BACKGROUND OF THE INVENTION

1. Field of the Invention

The present invention relates to a glass funnel for a cathode-ray tube. More particularly, the present invention relates to a technique for forming a positioning reference portion used for sealing the glass funnel to a glass panel for a cathode-ray tube on the glass funnel in which a relatively thick region is formed around an outermost line of a body portion.

2. Description of the Related Art

As is known, a glass bulb for a cathode-ray tube is formed by a glass panel (hereinafter, simply referred to as a panel), arranged on the front side of the glass bulb, for displaying an image thereon; a glass funnel (hereinafter, simply referred to as a funnel) arranged at the back of the panel and sealed to the panel; and a neck sealed to the funnel, in which an electron gun is accommodated. On the outside of the funnel, a deflection yoke is mounted.

The panel includes a face part having an effective display screen on which an image is displayed and a skirt part that continues into the face part via a blend R part. The skirt part includes an end having an approximately rectangular wide opening, i.e., a seal-edge face, which is used for sealing the panel to the funnel. The skirt part has two longer sides opposed to each other and two shorter sides opposed to each other.

The funnel includes an approximately rectangular wide opening end, i.e., a seal-edge face and an approximately circular narrow opening end along a tube axis. The wide opening end is used for sealing the funnel to the panel, while the narrow opening end is used for sealing the neck to the funnel. The side wall of the funnel, which has a center axis aligned with the tube axis, has a funnel-like shape and includes a body portion that extends from the wide opening end to reach a predetermined position on the narrow opening end side of the side wall thereof and a yoke portion next to the body portion on the narrow opening end side. The body portion has two longer sides opposed to each other and two shorter sides opposed to each other. The wide opening end of the body portion of the funnel is made to adhere to the end of the skirt part of the panel with flit glass interposed therebetween by sealing.

In recent years, this type of cathode-ray tube has become heavier with improvement of the flatness of the face part (front face) of the panel and increase of the effective screen size. In order to overcome this problem, the weight of the cathode-ray tube is reduced mainly by thinking out the shape of the funnel in various ways. As one particular solution, a region of the funnel other than a region around the wide opening end is made thinner. More specifically, while the thickness of the wide opening end is kept to have an appropriate thickness so as to ensure a required degree of sealing strength with respect to the panel, the region other than the region around the wide opening end is made thinner.

In this case, the funnel has a shape in which a step is provided at a junction of the outside surface of the region near the wide opening end and the outside surface of the other region positioned on the narrow opening end side of the region near the wide opening end so that the outside surface of the region near the wide opening end is elevated outside (see Japanese Patent Application Publications No. 2002-237266 and No. 2002-237267, for example). Alternatively, in order to achieve high degree of sealing strength, a thick region having the elevated outside surface is formed around the wide opening end without entirely reducing the thickness of the funnel.

On the other hand, in order to achieve a cathode-ray tube having the structure that can display an appropriate image with no color shift or the like, it is significant that the panel, funnel and neck are assembled with their center axes precisely aligned with respect to the tube axis of the glass bulb. Therefore, positioning reference portions used for positioning in sealing the funnel to the panel are provided at least three positions on the outside surfaces of the adjacent sides of the body portion of the funnel. For example, the positioning reference portions are provided at two positions on the outside surface near both ends of the longer side of the body portion in the circumferential direction and a position on the outside surface of the shorter side. The positioning reference portion is brought into contact with a jig when the funnel is sealed to the panel, thereby precisely positioning the funnel with respect to the panel. The positioning reference portion has a convex shape having a reference surface to be brought into contact with the jig on its top. The reference surface is formed to be away from the center axis of the funnel by a predetermined distance.

Thus, the above-described funnel in which the thick region having the elevated outside surface is formed around the wide opening end also requires the above positioning reference portion used for sealing the funnel to the panel. Therefore, as shown in FIGS. 7(a) and 7(b), the convex positioning reference portion 10′ is formed integrally with the outside surface 11a′ of the thick region 11′ provided around the wide opening end 2′ of the body portion 5′ of the funnel so as to overlap the outside surface 11a′ (see Japanese Patent Application Publication No. 2002-197992 (FIG. 1), for example). Please note that only a part of the positioning reference portion 101 that projects from the outside surfaces 11a′ and 12a′ of the thick region 11′ and the thin region 12′ is shown with hatching in FIG. 7(a).

The main reason why the positioning reference portion 10′ is formed to overlap the thick region 11′ of the body portion 5′ is as follows. In a case where the positioning reference portions 10′ are formed on the outside surfaces of both the thick region 11′ and the thin region 12′ of the body portion 5′ so as to have the same protrusion dimension (the same protrusion thickness), a ratio of the thickness of the positioning reference portion 10′ to the total thickness of the thick region 11′ and positioning reference portion 10′ is smaller than a ratio of the thickness of the positioning reference portion 10′ to the total thickness of the thin region 12′ and positioning reference portion 10′. Therefore, a ratio of increase of heat capacity of a portion having the positioning reference portion 10′ to a portion having no positioning reference portion 10′ is smaller in the thick region 11′ than that in the thin region 12′. Thus, it can be considered that glass temperature distribution in molding of glass becomes relatively uniform in a case of forming the positioning reference portion 10′ in the thick region 11 as compared to a case of forming the positioning reference portion 10′ in the thin region 12′, thereby providing excellent moldability.

According to the conventional technique, in a case of forming the positioning reference portion 10′ in the thick region 11′ of the body portion 5′, the dimension t of protrusion from the outside surface 11a′ of the thick region 11′ to the outside surface (reference surface) 10a′ of the positioning reference portion 10′ was determined mainly for allowing the existence of the reference surface 10a′ to be easily perceived. In other words, if this dimension t is inappropriately small, it is difficult to perceive the reference surface 10a′ of the positioning reference portion 10′, thus causing a mistake in sealing of the funnel to the panel or making work more difficult. Therefore, this dimension t of the protrusion was determined to fall within a range from about 2 mm to about 2.5 mm, considering safety (margin) against perception error of the positioning reference portion 10′.

However, the above range (about 2 mm to about 2.5 mm) of the dimension of the protrusion extending from the outside surface of the body portion to the reference surface of the positioning reference portion was also applied to the funnel having no thick region around the wide opening end. In other words, the above range of the protrusion dimension was not a particular range for the funnel having the thick region.

Therefore, due to the inclusion of the thick region, there was a possibility that forming defect occurred by reasons that could not be expected in the funnel having no thick region. More specifically, the formation of the thick region 11′ increases the heat capacity in the thick region 11′ as compared to that in the thin region 12′. If the positioning reference portion 10′ is further formed in the thick region 11′, the heat capacity at a portion of the thick region 11 at which the positioning reference portion 10′ exists becomes considerably large as compared to the heat capacity in the thin region 12′. This causes loss of glass temperature balance between the thick region 11′ and the corresponding thin region 12′. Moreover, when such a funnel was cooled, a conventional cooling method was used. Therefore, deterioration of the flatness or dimensional error of the reference surface 10a′ in the positioning reference portion 10′ occurred as well as forming defect such as generation of a crack or wrinkle around the region near the positioning reference portion 10′.

Therefore, the present invention was made considering the aforementioned situation. The problem to be solved by the present invention is to suppress the loss of glass temperature balance between a portion at which the positioning reference portion is formed and other portions around that portion in molding of the funnel including the thick region, thereby reducing occurrence probability of forming defect such as deterioration of flatness or dimensional error in the positioning reference portion.

### SUMMARY OF THE INVENTION

In order to solve the above problem, it is a main object of the present invention to, in a glass funnel for a cathode-ray tube including a thick region around a wide opening end having a wide opening of a body portion, suppress excessive loss of glass temperature balance due to the existence of the thick region and occurrence of forming defect caused by that loss of the glass temperature balance. The present invention was made by focusing attention on that, even if a relative position of a positioning reference portion with respect to the wide opening end or tube axis was largely changed from the position in accordance with the conventional technique, such a change had no effect on the funnel by improving the structure of the jig that came into contact with a reference surface of the positioning reference portion in sealing of the funnel to a glass panel.

In view of the foregoing, according to the present invention, a glass funnel for a cathode-ray tube comprising a funnel-like side wall is provided. One end of the side wall is an approximately rectangular wide opening end thereof, having an approximately rectangular wide opening along a tube axis, while the other end of the side wall is an approximately circular narrow opening end thereof, having an approximately narrow opening along the tube axis. The side wall has a body portion extending from the wide opening end toward the narrow opening end, and a yoke portion continuing from the body portion to the narrow opening end. In this configuration, a step is provided at a junction between an outside surface of a first region and an outside surface of a second region of the body portion, so as to make a thickness of the first region thicker than a thickness of the second region, in which the first region extends from an outermost line of the body portion along the tube axis toward the narrow opening end to reach a position away from the outermost line by a predetermined distance h, and the second region is positioned at the side of the narrow opening end closer than the first region. The present invention is characterized in that a positioning reference portion used for sealing of the funnel to a glass panel for the cathode-ray tube is formed only on the outside surface of the second region.

The “first region” means a region in which a thick region is formed. Please note that, if any part exists on the wide opening end side apart from the outermost line that is the one end of the first region, this part is also included in the thick region generally. Moreover, in a case where an end portion on the narrow opening end side of a flat surface or substantially flat surface that has a required mold releasing angle with respect to a direction parallel to the tube axis continues into the outside surface of the second region via a convex arc-shaped surface having a relatively small radius of curvature, the “outside surface of the first region” means a surface formed by the aforementioned flat surface or substantially flat surface and the convex arc-shaped surface continuing therefrom. On the other hand, the “second region” means a region in which a thin region is formed. Moreover, in a case where the end portion on the wide opening end side of a curved surface that gradually approaches to the tube axis as it goes toward the narrow opening end without rapid change of the thickness continues into the outside surface of the first region via a concave arc-shaped surface having a relatively small radius of curvature, the “outside surface of the second region” means a surface formed by the above curved surface and the concave arc-shaped surface continuing therefrom. In a case where the convex arc-shaped surface continues directly into the concave arc-shaped surface, a junction point between them serves as a boundary between the outside surface of the first region and the outside surface of the second region. In another case where the convex arc-shaped surface and the concave arc-shaped surface continue into both ends of a flat surface between them, respectively, the center position between the junction point of the flat surface and the convex arc-shaped surface and the other junction point of the flat surface and the concave arc-shaped surface serves as the between the outside surface of the first region and the outside surface of the second region. Therefore, the “step” is formed by the convex arc-shaped surface and the concave arc-shaped surface and, the flat surface in the case where the flat surface exists between the convex arc-shaped surface and the concave arc-shaped surface. Furthermore, the “reference surface of the positioning reference portion” is a surface that is approximately parallel to the tube axis and has a minimum mold releasing angle with respect to, for example, molds.

According to the above structure, the positioning reference portion is only on the outside surface of the second region serving as a thin region, but no positioning reference portion exists in the first region serving as a thick region. Therefore, as compared to a conventional case where the positioning reference portion is formed on the outside surface of the first region to be convex so that the dimension of protrusion to the reference surface is set to be in a range from about 2 mm to about 2.5 mm, inappropriate increase of the heat capacity caused by the increase of the thickness of the first region and inadequate cooling caused by that increase of the heat capacity can be suppressed. Thus, glass temperature balance between the first and second regions in molding of glass funnel can be improved. Also, adverse affects on glass temperature balance between a portion having the positioning reference portion formed therein and another portion having no positioning reference portion in the first region can be reduced. Therefore, excellent moldability can be ensured. Moreover, the second region serves as a thin region and is sufficiently cooled normally. Thus, even if the positioning reference portion is formed on the outside surface of the second region, there is little possibility that the formation of the positioning reference portion obstructs the cooling of the second region. In a case where the positioning reference portion is formed on the outside surface of the second region as described above, the distance of the reference surface from the wide opening end or tube axis may be largely changed as compared to the reference surface of the positioning reference portion that was brought into contact with a conventional jig during panel sealing operation. However, such a large change can be overcome by improvement of the jig or the use of a different type of jig.

In the above structure, it is preferable that the predetermined distance h along the tube axis from the outermost line of the body portion to an edge on the narrow opening end side of the first region satisfies the relation of 2 mm<h<15 mm, and a distance i, that is measured from the outermost line of the body portion to an edge of the positioning reference portion at the wide opening end along the tube axis, satisfies the relation of i<h+20 mm.

In this case, when the distance h is 2 mm or less, maintenance of molds becomes difficult. Also, such a short distance h is disadvantageous to sufficient weight reduction of the funnel and ensuring of a required degree of sealing strength with respect to the panel. On the other hand, when the distance h is 15 mm or more, an area of the thick region is too large to cool. The inadequate cooling may lead to forming defect such as deterioration of flatness of the reference surface of the positioning reference portion. From that point of view, it is preferable that the distance h fall within the aforementioned range. On the other hand, the positioning reference portion may be formed from the aforementioned concave arc-shaped surface, that forms the step in the outside surface of the second region, or a half of the flat surface continuing into that concave arc-shaped surface, that is a half closer to the junction between the flat surface and the concave arc-shaped surface, toward the narrow opening end. Alternatively, the positioning reference portion may be formed from a position on the narrow opening end side apart from the step in the outside surface of the second region (i.e., a position on the aforementioned curved surface) toward the narrow opening end. In this case, the grade of the body portion gradually becomes gentler as the body portion goes toward the narrow opening end, i.e., toward the yoke portion. Therefore, when the distance i is equal to or larger than (h+20) mm, the grade of the outside surface of the second region becomes too gentle. If the positioning reference portion having the reference surface approximately parallel to the tube axis is formed on the outside surface having such a gentle grade, the thickness of the positioning reference portion (the volume of the protrusion) becomes inappropriately large and therefore the glass temperature balance around the positioning reference portion in the second region is lost. This may lead to forming defect. From this point of view, it is preferable that the distance i be set to fall within the aforementioned range.

In the above structure, it is preferable that an entire region of the reference surface of the positioning reference portion be positioned inside the outside surface of the first region, i.e., on the tube-axis side of the outside surface of the first region.

More specifically, a case where the positioning reference portion is formed near the first region is considered as an example. When the reference surface of the positioning reference portion is positioned outside the outside surface of the first region, a portion between the positioning reference portion and the outside surface of the first region may have a complicated shape having a dent or the like. This also makes design and production of a bottom mold complicated or deteriorates the glass temperature balance around that portion so as to cause forming defect. However, when the entire region of the reference surface of the positioning reference portion is positioned inside the outside surface of the first region, the shape of the portion around the positioning reference portion does not become complicated even if the positioning reference portion is formed in the vicinity of the first region. Thus, the design and production of the mold and molding work can be performed easily, contributing to the reduction of the production cost. Moreover, the situation in which the reference surface of the positioning reference portion protrudes inappropriately can be avoided, thus reducing the loss of the glass temperature balance around the positioning reference portion and the occurrence probability of forming defect caused by that loss of the glass temperature balance.

In the above structure, it is preferable that the reference surface of the positioning reference portion be unpolished.

In this case, the glass funnel for a cathode-ray tube having the high-quality positioning reference portion can be manufactured by appropriately figuring out temperature characteristics of glass and the like and appropriately performing temperature control and the like in molding of glass by pressing. Moreover, polishing after the molding is not required. Therefore, it is possible to reduce the effort and cost required for manufacturing.

As described above, according to the glass funnel for a cathode-ray tube of the present invention, in the structure including the first region serving as the thick region formed around the wide opening end of the body portion and the second region serving as the thin region formed adjacent to the first region on the narrow opening end side closer than the first region, the positioning reference portion is formed only on the outside surface of the second region while no positioning reference portion is formed in the first region. Therefore, as compared to the conventional funnel, inappropriate increase of the heat capacity caused by the increase of the thickness of the first region and the obstruction of cooling caused by that increase of the heat capacity can be suppressed. Thus, the glass temperature balance between the first region and the second region in molding can be improved. Also, adverse affects on the glass temperature balance between a portion having the positioning reference portion formed therein and a portion having no positioning reference portion in the first region can be suppressed. Therefore, excellent moldability can be ensured. Moreover, the second region serves as the thin region and therefore it can be cooled sufficiently. Thus, if the positioning reference portion is formed on the outside surface of the second region, there is little possibility that such formation obstructs the cooling of the second region. Therefore, it is possible to keep moldability excellent.

In this case, by setting a distance h, that is a distance along the tube axis from the outermost line near the wide opening end of the body portion to the edge on the narrow opening end side of the first region, to satisfy the relation of 2 mm<h<15 mm and setting a distance i, that is measured from the outermost line of the body portion to an edge of the positioning reference portion at the wide opening end along the tube axis to satisfy the relation of i<h+20 mm, maintenance of the molds can be easy to perform. Also, such setting of the distances h and i is advantageous to sufficient weight reduction of the funnel and ensuring of a required degree of sealing strength with respect to the panel. Moreover, occurrence of the difficulty of cooling caused when the area of the thick region becomes too large and the forming defect around the positioning reference portion can be avoided appropriately. Furthermore, inappropriate increase of the thickness of the positioning reference portion caused when the grade of the outside surface of the second region becomes too gentle, loss of the glass temperature balance caused by that inappropriate increase of the thickness, and occurrence probability of forming defect or the like can be reduced.

In addition, by forming the positioning reference portion in such a manner that the entire reference surface is positioned inside the outside surface of the first region, it is possible to prevent the shape of the portion around the positioning reference portion from becoming complicated even in a case where the positioning reference portion is formed near the first region. Therefore, the design and production of the mold and the molding work can be performed easily, thus contributing to the reduction of production cost. Also, it is possible to prevent inappropriate protruding of the reference surface of the positioning reference portion, thus reducing the loss of the glass temperature balance around the positioning reference portion and the occurrence probability of forming defect caused by that loss of the glass temperature balance.

Moreover, in a case where the reference surface of the positioning reference portion is left unpolished, it is possible to manufacture the glass funnel for a cathode-ray tube having the high-quality positioning reference portion by appropriately figuring out temperature characteristics of glass and the like and appropriately performing temperature control and the like in molding of glass by pressing. Also, polishing after molding is not required. Therefore, the effort and cost required for manufacturing the glass funnel can be reduced.

### BRIEF DESCRIPTION OF THE DRAWINGS

In the accompanying drawings:

FIG. 1 is a perspective view of a glass funnel for a cathode-ray tube according to a first embodiment of the present invention, showing the entire structure thereof;

FIG. 2(a) is a partially enlarged vertical cross-sectional view of the main part of the glass funnel according to the first embodiment of the present invention and FIG. 2(b) is a front view thereof;

FIG. 3(a) is a partially enlarged vertical cross-sectional view of the main part of a glass funnel according to a second embodiment of the present invention and FIG. 3(b) is a front view thereof;

FIG. 4(a) is a partially enlarged vertical cross-sectional view of the main part of a glass funnel according to a third embodiment of the present invention and FIG. 4(b) is a front view thereof;

FIG. 5 is a perspective view of a glass funnel according to the fourth embodiment of the present invention, showing the entire structure thereof;

FIG. 6 is a perspective view of a glass funnel that is not in accordance with the embodiments of the present invention and is not included in the scope of the present invention, showing the entire structure thereof; and

FIG. 7(a) is a partially enlarged vertical cross-sectional view of a main part of a conventional glass funnel, and FIG. 7(b) is a front view thereof.

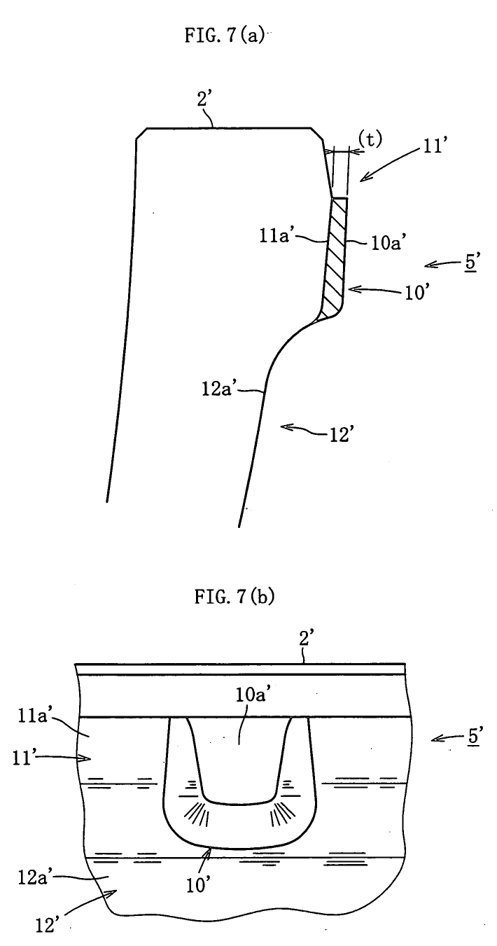

### DETAILED DESCRIPTION OF THE PREFERRED EMBODIMENTS

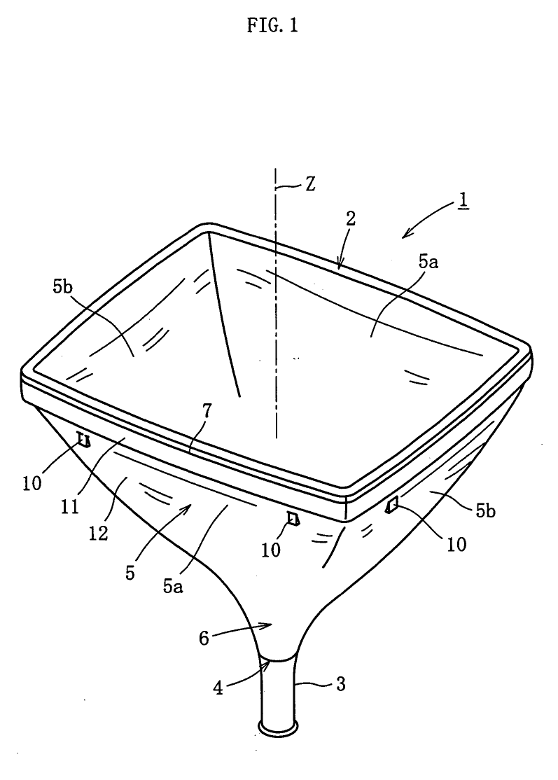

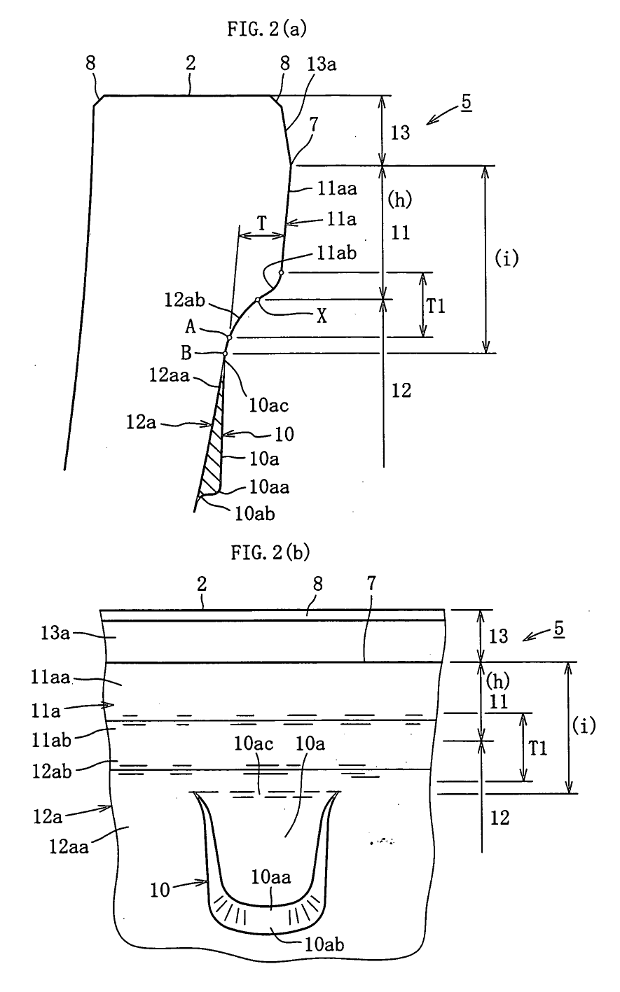

Hereinafter, embodiments of the present invention are described with reference to the attached drawings. FIG. 1 is a perspective view of a glass funnel for a cathode-ray tube according to a first embodiment of the present invention, showing the entire structure of the glass funnel. FIG. 2(a) is a partially enlarged vertical cross-sectional view and FIG. 2(b) is a partially enlarged front view of one side of the glass funnel.

As shown in FIG. 1, the funnel 1 according to the first embodiment of present invention includes an approximately rectangular wide opening end (seal-edge face) 2 having an approximately rectangular wide opening in Z-direction along the tube axis. At the wide opening end 2, the funnel 1 is sealed to a panel (not shown). The funnel 1 also includes an approximately circular narrow opening end 4 having an approximately circular narrow opening in Z-direction. At the narrow opening end 4, a neck 3 is sealed to the funnel 1. A side wall of the funnel 1 has an approximately funnel-like shape with its center axis aligned with the tube axis Z. The side wall includes a body portion 5 that extends from the wide opening end 2 to reach a predetermined position on the narrow opening end side and a yoke portion 6 that continues into the body portion 5 on the narrow opening end side of the body portion 5. The body portion 5 has two longer sides 5a opposed to each other and two shorter sides 5b opposed to each other.

In the body portion 5, a mold match line 7 serving as an outermost line is formed at a position spaced away from the seal-edge face 2 toward the narrow opening end 4 by a small distance, as shown in FIGS. 2(a) and 2(b). Moreover, chamfered portions 8 are formed on inner and outer ends of the seal-edge face 2, i.e., both ends of the seal-edge face 2 in the thickness direction. The mold match line 7 is formed when the funnel 1 is molded by pressing, so as to correspond to a matching face between a bottom mold and a shell mold for defining a female mold for the funnel 1.

Moreover, the body portion 5 includes a first region 11 and a second region 12 arranged on the narrow opening end side closer than the first region 11. The first region 11 extends from the mold match line 7 toward the narrow opening end 4 to reach a position spaced away from the mold match line 7 by a predetermined distance h along the tube axis Z. The thickness of the first region 11 is made thicker than that of the second region 12. In this case, the predetermined distance h satisfies the following relation: 2 mm<h<15 mm, and is set to 7 mm, for example. In order to make the thickness different between the regions 11 and 12, a step T is provided in a portion in which the outside surface 11a of the first region 11 continues into the outside surface 12a of the second region 12. In this embodiment, the thickness of a near-edge region 13 that is a region near the seal-edge face 2, i.e., a region between the mold match line 7 and the seal-edge face 2, is also made thicker than that of the second region 12. The second region 12 includes the yoke portion 6.

The outside surface 11a of the first region 11 is formed by a convex large-radius arc-shaped surface 11aa, that has a significantly large radius of curvature to approximate a flat surface, and a convex small-radius arc-shaped surface 11ab having a relatively small radius of curvature. The convex small-radius arc-shaped surface 11ab continues into the convex large-radius arc-shaped surface 11aa so as to be inscribed in the arc-shaped surface 11aa at the end portion on the narrow opening end side of the arc-shaped surface 11aa. On the other hand, the outside surface 12a of the second region 12 is formed by a curved surface 12aa, that gradually comes closer to the tube axis Z as it goes toward the narrow opening end 4 without rapid change of the thickness, and a concave small-radius arc-shaped surface 12ab having a relatively small radius of curvature. The concave small-radius arc-shaped surface 12ab continues into the curved surface 12aa in such a manner that the arc-shaped surface 12ab is circumscribed to the curved surface 12aa at the end portion on the wide opening end side of the curved surface 12aa. Moreover, the convex small-radius arc-shaped surface 11ab of the first region 11 continues into the concave small-radius arc-shaped surface 12ab of the second region 12 in such a manner that they are circumscribed. The junction point X serves as a boundary between the outside surfaces 11a and 12a of the first and second regions 11 and 12. In this case, the step T is provided in a step-forming region T1 formed by the convex small-radius arc-shaped surface 11ab and the concave small-radius arc-shaped surface 12ab. Please note that each of the convex large-radius arc-shaped surface 11aa, convex small-radius arc-shaped surface 11ab and concave small-radius arc-shaped surface 12ab may be an arc-shaped surface having a single radius of curvature or an arc-shaped surface having a plurality of radii of curvature in which two or more arc-shaped surfaces each having a different radius of curvature continue into each other to be inscribed.

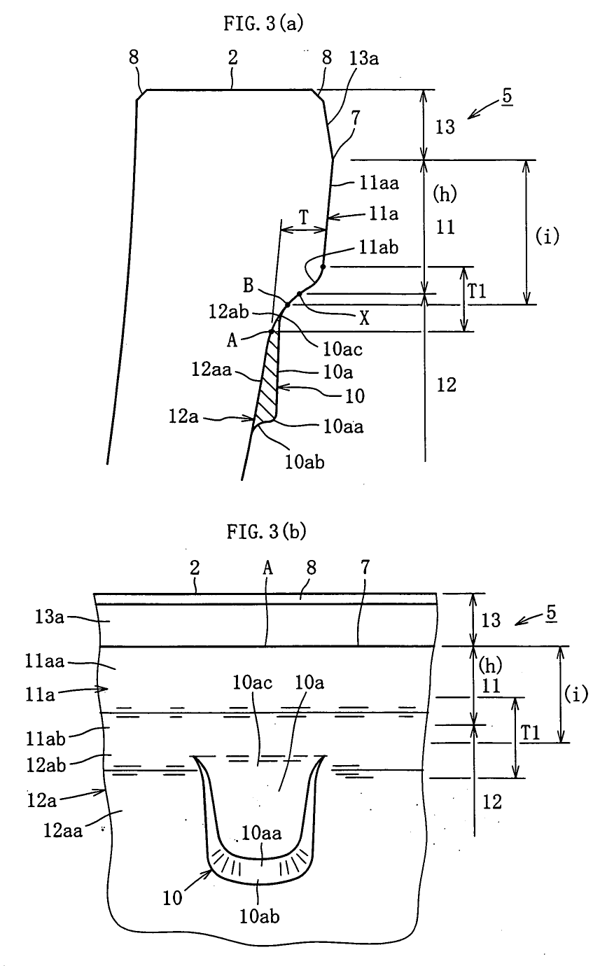

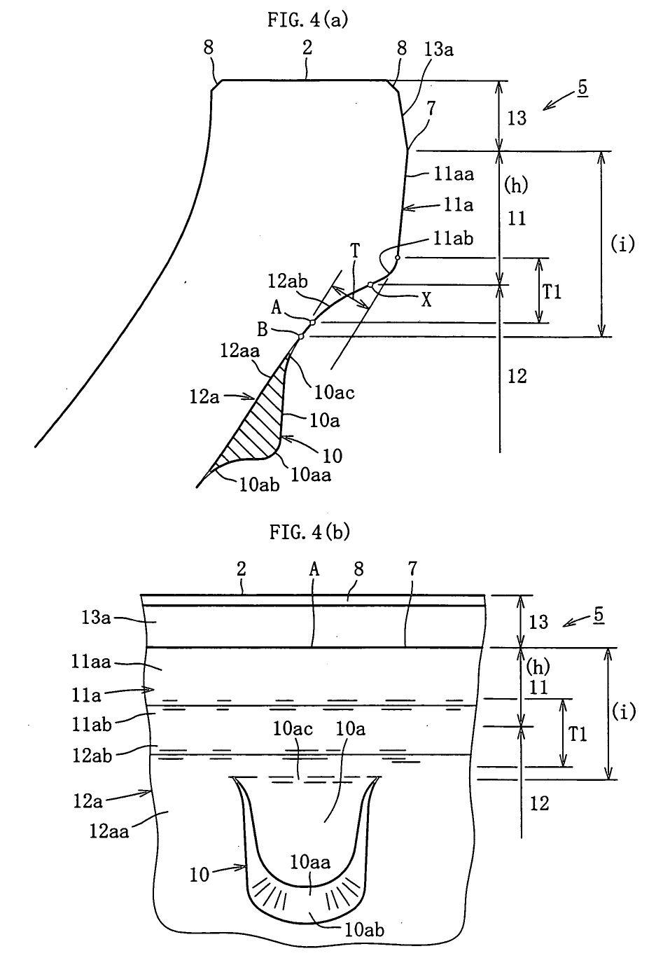

On the body portion 5, positioning reference portions 10, each having a reference surface 10a to be brought into contact with a jig when the funnel 1 is sealed to the glass panel, are formed at least three positions. More specifically, the positioning reference portions 10 are formed at positions near both ends of the longer side 5a in the circumferential direction (direction along the seal-edge face 2) and a position near wide opening end of the shorter side 5b. Those positions are arranged to put one corner between two of the positions. Please note that only a part of the positioning reference portion 10, which protrudes from the outside surface 12a of the second region 12, is shown with hatching in FIG. 2(a). (Hatching is added similarly in FIGS. 3(a) and 4(a).)

The positioning reference portion 10 is formed only on the outside surface 12a of the second region 12. In the present embodiment, the positioning reference portion 10 is formed from a position on the outside surface 12a of the second region 12, which is a position on the narrow opening end side apart from the concave small-radius arc-shaped surface 12ab (i.e., a position on the narrow opening end side apart from the step-forming region T1), to extend toward the narrow opening end 4. The reference surface 10a of the positioning reference portion 10 is positioned inside the outside surface 11a of the first region 11, as shown in FIG. 2(a). More specifically, the reference surface 10a is positioned inside the junction point A between the concave small-radius arc-shaped surface 12ab and the curved surface 12aa of the outside surface 12a of the second region 12.

The reference surface 10a is a flat surface parallel or approximately parallel to the tube axis Z, such as a flat surface having the minimum mold releasing angle with respect to a mold (bottom mold), and is an unpolished face that is not polished after the molding by pressing. An end of the reference surface 10a, which is positioned on the narrow opening end side of the reference surface 10a, continues into a convex small-radius arc-shaped surface 10aa having a radius of curvature that is the same as or smaller than that of the convex small-radius arc-shaped surface 11ab of the first region 11. Moreover, an end of the convex small-radius arc-shaped surface 10aa, which is positioned on the narrow opening end side of the surface 10aa, continues into a concave small-radius arc-shaped surface 10ab having a radius of curvature that is the same as or smaller than that of the concave small-radius arc-shaped surface 12ab of the second region 12 so as to be circumscribed to the surface 10ab. Furthermore, an end of the concave small-radius arc-shaped surface 10ab, which is positioned on the narrow opening end side of the surface 10ab, continues into the curved surface 12aa of the second region 12 so as to be circumscribed to the surface 12aa.

On the other hand, another end of the reference surface 10a, which is positioned on the wide opening end side of the reference surface 10a, smoothly continues into the curved surface 12aa of the second region 12 via a concave small-radius arc-shaped surface 10ac having a radius of curvature that is the same as or larger than that of the concave small-radius arc-shaped surface 12ab of the second region 12. The distance i from the mold match line 7 of the body portion 5 along the tube axis Z to an edge B on the wide opening end side of the positioning reference portion 10, i.e., a junction point B between the concave small-radius arc-shaped surface 10ac of the positioning reference portion 10 and the curved surface 12aa of the second region 12 satisfies the following relation with respect to a predetermined distance h from the mold match line 7 to the end portion on the narrow opening end side of the first region 11: i<h+20 mm. In this case, for h=7 mm, i is set to 13 mm, for example. Please note that each of the convex small-radius arc-shaped surface 10aa and the concave small-radius arc-shaped surfaces 10ab and 10ac of the positioning reference portion 10 may be an arc-shaped surface having a single radius of curvature or an arc-shaped surface having a plurality of radii of curvature in which two or more arc-shaped surfaces each having a different radius of curvature are inscribed.

As shown in FIG. 2(b), except for the end on the wide opening end side of the reference surface 10a, the circumference of the reference surface 10a continues into the outside surface 12a (curved surface 12aa) of the second region 12 via the convex small-radius arc-shaped surface 10aa and the concave small-radius arc-shaped surface 10ab as is the end on the narrow opening end side of the reference surface 10a. The outline of the reference surface 10a includes a straight line at the end on the wide opening end side and a curve in the remaining region. This curve is formed by a plurality of arcs having a plurality of radii of curvature continuing into one another to be inscribed.

According to the above structure, as compared to a case where the dimension of protrusion at least from the outside surface of the first region of the body portion to the reference surface of the positioning reference portion was set to be in a range from about 2 mm to about 2.5 mm like the conventional funnel, the volume of the protruding part of the positioning reference portion 10, that protrudes from the outside surface 12a (curved surface 12aa) of the second region 12 to the outside (shown with hatching in FIG. 2(a)) is reduced. With that volume reduction, a region in which the entire circumference of the reference surface 10a is coupled to the curved surface 12aa of the second region 12 (especially, the convex small-radius arc-shaped surface 10aa and the concave small-radius arc-shaped surface 10ab) also becomes narrower. In addition, the heat capacity of the first region 11 does not increase as compared to the conventional funnel. Thus, glass temperature balance between the first region 11 and the second region 12 when the funnel 1 is molded by pressing is improved. The loss of the glass temperature balance between a portion in which the positioning reference portion 10 is formed and another portion which has no positioning reference portion 10 in the first region 11 is also prevented. Moreover, the second region 12 is a thin region and is sufficiently cooled normally in molding by pressing. Therefore, if the positioning reference portion 10 is formed on the outside surface 12a of the second region 12, there is little possibility that the formation of the positioning reference portion 10 obstructs the cooling of the second region 12. Thus, it is possible to ensure excellent moldability of the funnel 1 with respect to the positioning reference portion 10.

FIG. 3(a) is a partially enlarged vertical cross-sectional view of the main part of the funnel according to a second embodiment of the present invention, and FIG. 3(b) is a front view thereof. The funnel 1 of the second embodiment includes the positioning reference portion 10 on the outside surface 12a of the second region 12 in such a manner that the portion 10 starts from the concave small-radius arc-shaped surface 12ab and extends toward the narrow opening end 4. In this case, it is preferable that, at the start position B of the positioning reference portion 10, the edge of the reference surface 10a on the wide opening end side smoothly continue into the concave small-radius arc-shaped surface 12ab of the second region 12 via the concave small-radius arc-shaped surface 10ac. Except for the above, the main structure of the funnel 1 of the second embodiment is the same as that of the funnel 1 of the first embodiment. Accordingly, the main components common to the first and second embodiments are labeled with the same reference numerals in FIGS. 3(a) and 3(b) and therefore the description thereof is omitted.

FIG. 4(a) is a partially enlarged vertical cross-sectional view of the main part of the funnel according to the third embodiment of the present invention, and FIG. 4(b) is a front view thereof. In the third embodiment, the present invention is applied to the funnel 1 in which the grade of the outside surface 12a of the second region 12 is gentler as compared to the first and second embodiments described above. Except for the above, the main structure of the funnel 1 of the third embodiment is the same as that of the funnel 1 of the first embodiment. Accordingly, the main components common to the first and third embodiments are labeled with the same reference numerals in FIGS. 4(a) and 4(b) and therefore the description thereof is omitted.

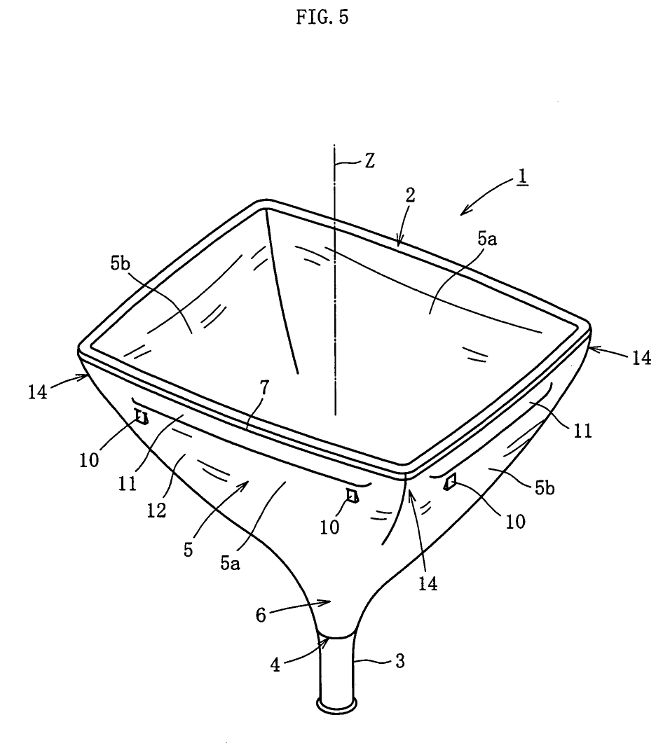

Although the present invention is applied to the funnel 1 in which the first region 11 is formed along the entire circumference of the body portion 5 in the first, second and third embodiments, the present invention is not limited thereto. For example, as shown in FIG. 5, the present invention can be applied to a funnel 1 having the first region 11 formed in a region other than corners 14, i.e., a funnel 1 in which no first region 11 is formed at the corners 14, in a similar manner. Therefore, the positioning reference portion 10 is also formed in the second region 12 of the body portion 5 that is positioned on the narrow opening end side apart from the first region 11 as in the first, second and third embodiments.

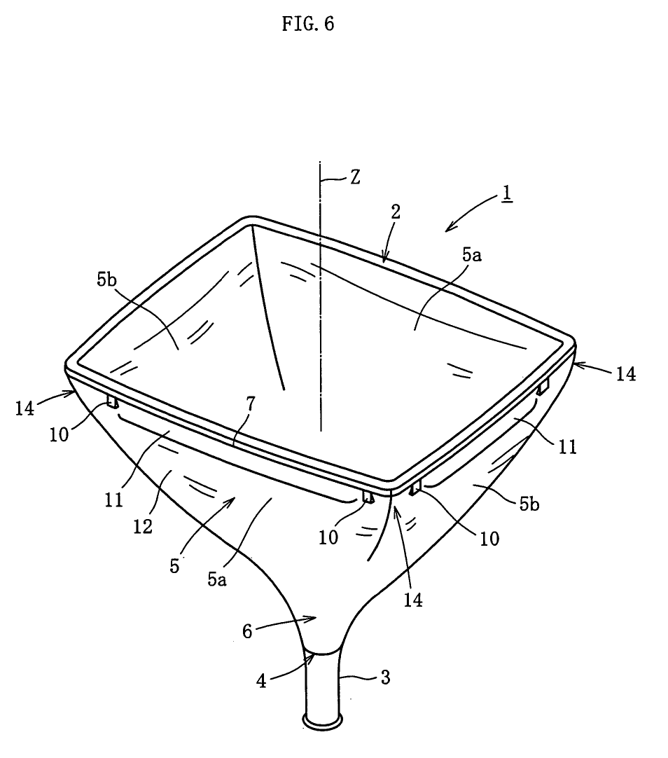

However, a funnel 1 in which the positioning reference portion 10 is formed at a position outside the second region 12 that is positioned on the narrow opening end side of the first region 11, as shown in FIG. 6, is out of the scope of the present invention, even if that funnel 1 includes the first region 11 formed in a region other than the corners 14. In the shown example, the positioning reference portion 10 is formed to extend from the mold match line 7 toward the narrow opening end 4.

What is claimed is:

1. A glass funnel for a cathode-ray tube, comprising a funnel-like side wall, one end of the side wall being an approximately rectangular wide opening end thereof, having an approximately rectangular wide opening along a tube axis, the other end of the side wall being an approximately circular narrow opening end thereof, having an approximately narrow opening along the tube axis,
the side wall having a body portion extending from the wide opening end toward the narrow opening end, and a yoke portion continuing from the body portion to the narrow opening end, wherein
a step is provided at a junction between an outside surface of a first region and an outside surface of a second region of the body portion, so as to make a thickness of the first region thicker than a thickness of the second region, the first region extending from an outermost line of the body portion along the tube axis toward the narrow opening end to reach a position away from the outermost line by a predetermined distance h, the second region positioned at the side of the narrow opening end closer than the first region, and wherein
a positioning reference portion used for sealing of the funnel to a glass panel for the cathode-ray tube is formed only on the outside surface of the second region.

2. A glass funnel as claimed in claim 1, wherein the predetermined distance h satisfies the relation of 2 mm<h<15 mm, and wherein a distance i, that is measured from the outermost line of the body portion to an edge of the positioning reference portion at the wide opening end along the tube axis, satisfies the relation of i<h+20 mm.

3. A glass funnel as claimed in claim 1, wherein an entire region of a reference surface of the positioning reference portion is positioned inside the outside surface of the first region.

4. A glass funnel as claimed in claim 2, wherein an entire region of a reference surface of the positioning reference portion is positioned inside the outside surface of the first region.

5. A glass funnel as claimed in any one of claim 1, wherein a reference surface of the positioning reference portion is unpolished.

6. A glass funnel as claimed in any one of claim 2, wherein a reference surface of the positioning reference portion is unpolished.

7. A glass funnel as claimed in any one of claim 3, wherein a reference surface of the positioning reference portion is unpolished.

8. A glass funnel as claimed in any one of claim 4, wherein a reference surface of the positioning reference portion is unpolished.
